(19) United States
(12) Patent Application Publication
(10) Pub. No.: US 2012/0021285 A1
(43) Pub. Date: Jan. 26, 2012

(54) NEGATIVE ELECTRODE FOR LITHIUM ION SECONDARY BATTERY, METHOD FOR PRODUCING THE SAME, AND LITHIUM ION SECONDARY BATTERY

(76) Inventors: Yasutaka KOGETSU, Osaka (JP); Takuhiro NISHIMURA, Osaka (JP)

(21) Appl. No.: 13/167,284

(22) Filed: Jun. 23, 2011

(30) Foreign Application Priority Data
Jul. 21, 2010 (JP) 2010-163753

(51) Int. Cl. H01M 4/134; H01M 4/1395

(52) U.S. Cl. 429/218.1; 429/209; 29/623.3; 29/623.1

(57) ABSTRACT

A negative electrode for a lithium ion secondary battery includes a current collector and a negative electrode active material layer supported on a surface of the current collector. The negative electrode active material layer includes a plurality of granular particles that include an alloyable active material. The granular particles are supported on a region of the current collector excluding a peripheral region that has a width of 20 μm to 500 μm from the edge thereof.

### FIELD OF THE INVENTION

This invention relates to a negative electrode for a lithium ion secondary battery, a method for producing the same, and a lithium ion secondary battery. More particularly, the invention relates to an improvement in the negative electrode for a lithium ion secondary battery which uses an alloyable active material as a negative electrode active material.

### BACKGROUND OF THE INVENTION

It is known that lithium ion secondary batteries using an alloyable active material as a negative electrode active material (hereinafter may be referred to as “alloy-type secondary batteries”) have higher capacity and energy density than conventional lithium ion secondary batteries using graphite as a negative electrode active material. Therefore, alloy-type secondary batteries are expected to be used as the main power source or auxiliary power source for transport devices, machine tools, etc., in addition to the power source for electronic devices. An alloyable active material absorbs lithium to form an alloy with lithium, and releases the lithium from the alloy. Examples of known alloyable active materials include silicon-based active materials such as silicon and silicon oxides and tin-based active materials such as tin and tin oxides.

However, the particles of an alloyable active material expand significantly during charge to cause an internal stress. As a result, they may cause the negative electrode active material layer to fall off the negative electrode current collector or may cause the negative electrode to deform.

Techniques for reducing the internal stress created by expansion of an alloyable active material have been studied. One such example is an alloy-type negative electrode in which a plurality of micron size columnar particles comprising an alloyable active material are supported on a current collector surface (see Patent Document 1 (International Publication WO 2008/026595)). In such an alloy-type negative electrode, gaps are formed between adjacent columnar particles, and the gaps serve to reduce the internal stress created by expansion of the alloyable active material. That is, even when the alloyable active material expands significantly during charge, occurrence of stress is suppressed by the gaps formed between the adjacent columnar particles. As a result, fall-off of the alloyable active material from the negative electrode current collector or deformation of the negative electrode is suppressed.

Patent Document 2 (Japanese Laid-Open Patent Publication No. 2005-317496) discloses a method for producing an electrode, including the step of cutting an electrode sheet, in which an active material layer comprising an active material and a resin binder is supported on a current collector surface, with a gang slitter. In this method, fall-off of the active material layer at side ends (cut sections) is suppressed. In the gang slitter, a side face of an upper blade and a side face of a lower blade face each other, and the clearance between the side face of the upper blade and the side face of the lower blade is 20 μm to 50 μm. However, when an alloy-type negative electrode is cut with a gang slitter, columnar particles in the peripheral region may remain, or columnar particles in the region excluding the peripheral region may be destroyed or removed.

### BRIEF SUMMARY OF THE INVENTION

In the process of assembling a secondary battery, first, a large positive electrode sheet and a large negative electrode sheet are cut to obtain a positive electrode and a negative electrode which have predetermined dimensions. A separator is interposed between these positive and negative electrodes, and they are stacked or wound to form an electrode assembly. In this case, the cut sections of the positive electrode sheet and the negative electrode sheet are the side ends of the positive electrode and the negative electrode. The side ends of the negative electrode are exposed at the side end faces of the electrode assembly.

In the case of using a negative electrode including a large number of columnar particles formed on a current collector surface, several hundreds to several tens of thousands of columnar particles regularly align with minute gaps therebetween at the side ends of the negative electrode exposed at the side end faces of the electrode assembly. When a secondary battery including such an electrode assembly is charged and discharged, the columnar particles at the side ends of the negative electrode forming the side end faces of the electrode assembly protrude outwardly from the electrode assembly due to expansion and contraction of the alloyable active material. Since the alloyable active material is glassy and brittle, the columnar particles may break and separate from the current collector. The broken pieces of the separated columnar particles may penetrate the separator to cause internal micro short circuits.

Also, there is another problem in the industrial production process due to the brittleness of an alloyable active material. In the process of assembling a secondary battery, for example, the edge of the above-described negative electrode may be gripped with a gripper to transport the negative electrode. In such cases, the brittle columnar particles positioned at the edge of the negative electrode gripped with the gripper may become broken or chipped by the gripping force. The pieces of the broken or chipped columnar particles remaining in the electrode assembly may cause internal micro short circuits.

An object of the invention is to provide a negative electrode for a lithium ion secondary battery having granular particles including an alloyable active material, wherein occurrence of broken pieces of the active material due to chipping of the granular particles at the edge of the negative electrode is suppressed.

The negative electrode for a lithium ion secondary battery according to the invention is a negative electrode for a lithium ion secondary battery including a current collector and a negative electrode active material layer supported on a surface of the current collector, the negative electrode active material layer including a plurality of granular particles that include an alloyable active material. The granular particles are supported on a region of the current collector excluding a peripheral region that has a width of 20 μm to 500 μm from the edge thereof. When such a negative electrode is used to produce an electrode assembly, it is possible to suppress the granular particles at the side end faces of the electrode assembly from protruding outwardly from the electrode assembly during charge. Also, even when the edge of the negative electrode is gripped with a gripper or the like, it is possible to suppress the alloyable active material from becoming chipped or separated from the current collector surface. As a result, the broken pieces of the granular particles are unlikely to be included in the electrode assembly.

Also, the method for producing a negative electrode for a lithium ion secondary battery according to the invention includes the steps of: (1) forming a negative electrode active material layer including a plurality of granular particles that include an alloyable active material on a surface of a current collector to produce a negative electrode sheet; and (2) cutting the negative electrode sheet to predetermined dimensions. The step (2) is performed with a gable slitter having an upper blade with an edge angle of 40° to 65° and a lower blade. According to this production method, a negative electrode for a lithium ion secondary battery as described above can be produced industrially with ease.

Also, the lithium ion secondary battery according to the invention includes a positive electrode capable of absorbing and releasing lithium ions, a negative electrode capable of absorbing and releasing lithium ions, a separator interposed between the positive electrode and the negative electrode, and a lithium-ion conductive non-aqueous electrolyte. In the lithium ion secondary battery, the negative electrode is the above-mentioned negative electrode for a lithium ion secondary battery.

According to the invention, it is possible to suppress the broken pieces of the granular particles including the alloyable active material from remaining in the electrode assembly. It is therefore possible to provide a highly safe lithium ion secondary battery in which occurrence of internal micro short circuits is suppressed.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a schematic longitudinal sectional view of the structure of a first embodiment of a lithium ion secondary battery according to the invention;

FIG. 2 is a schematic top view of the structure of a first embodiment of a negative electrode for a lithium ion secondary battery according to the invention;

FIG. 3 is a sectional view of the negative electrode for a lithium ion secondary battery illustrated in FIG. 2 cut along the line III-III;

FIG. 4 is a sectional view of the negative electrode for a lithium ion secondary battery illustrated in FIG. 2 cut along the line IV-IV;

FIG. 5 is a side view of the negative electrode for a lithium ion secondary battery illustrated in FIG. 2;

FIG. 6 is a schematic top view of the structure of a second embodiment of the negative electrode for a lithium ion secondary battery according to the invention;

FIG. 7 is a sectional view of the negative electrode for a lithium ion secondary battery illustrated in FIG. 6 cut along the line VII-VII;

FIG. 8 is a sectional view of the negative electrode for a lithium ion secondary battery illustrated in FIG. 6 cut along the line VIII-VIII;

FIG. 9 is a side view of the negative electrode for a lithium ion secondary battery illustrated in FIG. 6;

FIG. 10 is a schematic side view of the structure of a gable slitter used in a first embodiment of a method for producing a negative electrode for a lithium ion secondary battery according to the invention;

FIG. 11 is a schematic sectional view of the structure of the gable slitter illustrated in FIG. 10; and

FIG. 12 is a schematic view of the structure of a vacuum deposition device.

### DETAILED DESCRIPTION OF THE INVENTION

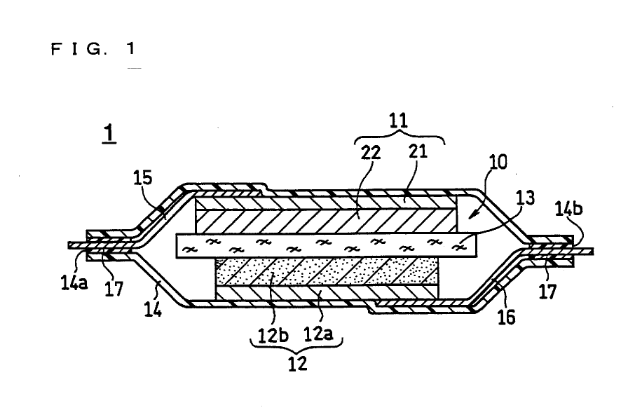

FIG. 1 is a schematic longitudinal sectional view of the structure of a first embodiment of a lithium ion secondary battery 1 according to the invention (hereinafter may be referred to as simply “battery 1”). The lithium ion secondary battery 1 has an electrode assembly 10 produced by stacking a negative electrode 11, a positive electrode 12, and a separator 13 interposed therebetween. The stacked electrode assembly 10 and a non-aqueous electrolyte (not shown) are housed in a battery case 14 having openings 14a and 14b at both ends. One end of a negative electrode lead 15 is connected to the negative electrode 11, while the other end is drawn from the opening 14a to outside of the battery case 14 of the battery 1. One end of a positive electrode lead 16 is connected to the positive electrode 12, while the other end is drawn from the opening 14b to outside of the battery case 14. At each of the openings 14a and 14b, a gasket 17 is disposed between the battery case 14 and the negative electrode lead 15 or the positive electrode lead 16. The openings 14a and 14b are sealed by welding the gaskets 17 to the inner faces of the openings 14a and 14b, respectively. The lithium ion secondary battery 1 of FIG. 1 is a battery having the stacked electrode assembly 10 packed in a laminated film, and is characterized by the negative electrode 11.

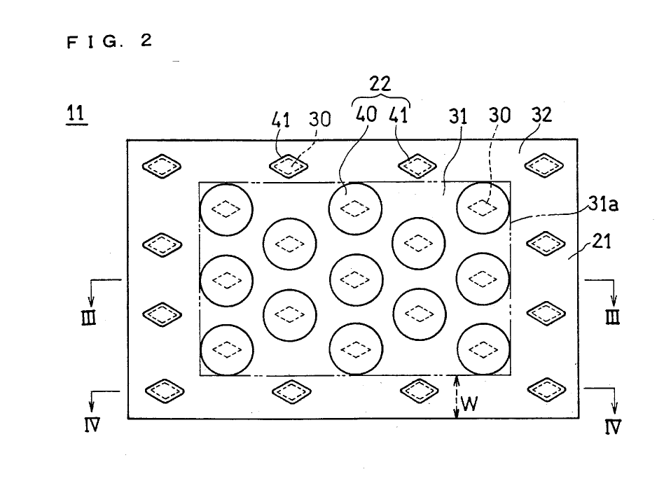

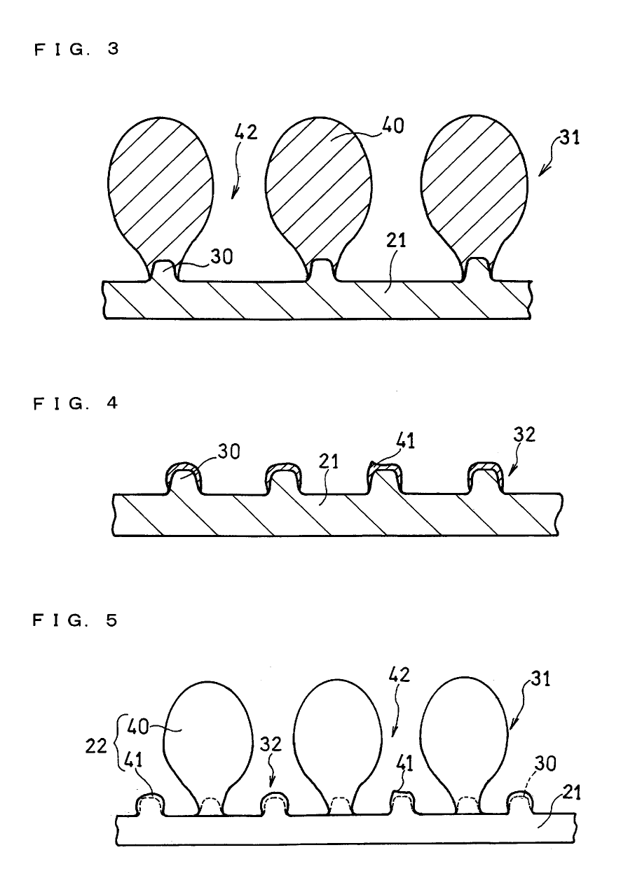

First, the negative electrode 11 of this embodiment is described with reference to FIG. 2 to FIG. 5. FIG. 2 is a schematic top view of the structure of a first embodiment of the negative electrode 11 according to the invention. FIG. 3 is a sectional view of the negative electrode 11 illustrated in FIG. 2 cut along the line III-III. FIG. 4 is a sectional view of the negative electrode 11 illustrated in FIG. 2 cut along the line IV-IV. FIG. 5 is a side view of the negative electrode 11.

As illustrated in FIG. 2, the negative electrode 11 includes a rectangular negative electrode current collector 21 and a negative electrode active material layer 22 including an alloyable active material and being supported on a surface of the negative electrode current collector 21. The negative electrode current collector 21 has a plurality of protrusions 30 on a surface. The negative electrode active material layer 22 includes a plurality of granular particles 40 which include the alloyable active material. As illustrated in FIG. 2 and FIG. 4, the granular particles are not supported on a peripheral region 32 of the negative electrode current collector 21 having a specific width from the edge thereof. As illustrated in FIG. 2, FIG. 3, and FIG. 5, the granular particles 40 are formed in a central region 31 of the negative electrode current collector 21 excluding the peripheral region 32, and are supported on the protrusions 30 of the negative electrode current collector 21.

In the central region 31, the granular particles 40 are spaced apart from one another. In FIG. 2, an edge 31a of the central region 31 is shown by the dot-dot dashed line connecting the outer surfaces of the outermost granular particles 40 of the central region 31 facing the edge of the negative electrode current collector 21. The region outside the edge 31a of the central region 31 is the peripheral region 32.

The peripheral region 32 is the region from the edge of the negative electrode current collector 21 to the edge 31a of the central region 31 where the granular particles 40 are not supported. The peripheral region 32 does not support the granular particles 40 but supports a thin film 41 formed on the surface of each protrusion 30. The thin films 41 include the alloyable active material. The thin films 41 may be formed by, for example, destroying or partially removing the granular particles 40.

Due to the absence of the granular particles 40 in the peripheral region 32 of the negative electrode 11, the following effects can be obtained. When the electrode assembly 10 is formed, exposure of the granular particles 40 at the side ends of the negative electrode 11 and the side end faces of the electrode assembly 10 is suppressed. As a result, chipping of the granular particles 40 during the production of the electrode assembly 10 is suppressed. Also, during charge, outward protrusion of the granular particles 40 from the side end faces of the electrode assembly 10 is suppressed. In addition, even when the edge of the negative electrode 11 is gripped during the production of the electrode assembly 10, breakage or chipping of the granular particles 40 is suppressed, so that fall-off of the granular particles 40 from the surfaces of the protrusions 30 can be suppressed. It is thus possible to suppress occurrence of broken pieces of the glassy, hard granular particles 40. As a result, when the lithium ion secondary battery 1 is assembled, inclusion of the broken pieces of the granular particles 40 in the electrode assembly 10 is suppressed. Therefore, it is possible to suppress occurrence of internal micro short circuits due to penetration of the broken pieces of the granular particles 40 into the separator. As such, a decrease in the safety and performance of the battery 1 due to occurrence of internal micro short circuits is reduced.

Next, the negative electrode current collector 21 and the negative electrode active material layer 22 are more specifically described.

The negative electrode current collector 21 is a metal foil made of a metal material such as copper, a copper alloy, stainless steel, or nickel.

The protrusions 30 extend outwardly from the surface of the negative electrode current collector 21. Since the protrusions are a part of the negative electrode current collector 21, they are made of the above-mentioned metal material. The adjacent protrusions 30 are spaced apart from one another. The negative electrode current collector 21 of this embodiment has the protrusions 30 on one surface, but it may have the protrusions 30 on both surfaces.

The thickness of the portion of the negative electrode current collector 21 not having the protrusions 30 is preferably 5 μm to 30 μm.

The arrangement of the protrusions may be regular or irregular. The protrusions 30 of this embodiment are arranged in a zigzag on the surface of the rectangular negative electrode current collector 21. The arrangement of the protrusions 30 is not particularly limited and can be, for example, a grid pattern. Preferably, the protrusions 30 are arranged so densely that sufficient gaps for reducing the stress created by expansion of the granular particles due to charge are formed between the adjacent granular particles.

The shape of the protrusions 30 in an orthographic projection of the negative electrode current collector 21 from vertically above is a rhombus in this embodiment. However, the shape is not limited to the rhombus and may be a polygon with three to eight sides, a parallelogram, a trapezoid, a circle, an oval, etc.

In this embodiment, the tip (top face) of each protrusion 30 is a flat plane that is substantially parallel to the surface of the negative electrode current collector 21. The top faces of the protrusions 30 may have minute irregularities.

The height of the protrusions 30 is preferably 3 μm to 15 μm, and more preferably 5 to 10 μm. The height of the protrusions 30 is the length of the normal to the surface of the negative electrode current collector 21 from the highest position of the top face of each protrusion 30 in a section of the negative electrode 11 in the thickness direction.

The width of the protrusions 30 is preferably 5 μm to 50 μm, and more preferably 10 to 40 μm. The width of the protrusions 30 is the greatest length of each protrusion 30 in a section parallel to the surface of the negative electrode current collector 21.

The height and width of the protrusions 30 can be determined by observing a section of the negative electrode 11 with a scanning electron microscope, measuring the heights and widths of, for example, 100 protrusions 30, and averaging the measured values. All the protrusions 30 do not need to have the same height or width.

The number of the protrusions 30 is preferably 10,000/cm² to 10,000,000/cm². The axis-to-axis distance between the adjacent protrusions 30 is preferably 10 μm to 100 μm, more preferably 10 to 50 μm, and even more preferably 10 to 30 μm. When the shape of the protrusions 30 is a rhombus, polygon, parallelogram, trapezoid, or oval, the axis of each protrusion 30 is an imaginary line passing through the point of intersection of the diagonal lines or the point of intersection of the major axis and the minor axis and extending linearly in the direction perpendicular to the surface of the negative electrode current collector 21. When the shape of the protrusions 30 is a circle, the axis of each protrusion 30 is an imaginary line passing through the center of the circle and extending linearly in the direction perpendicular to the surface of the negative electrode current collector 21.

The negative electrode current collector 21 can be produced by, for example, pressing a forged steel roller with a plurality of depressions formed in a surface against a stainless steel roller with a flat surface so that their axes are parallel to form a nip, and passing a metal foil through the nip. In this case, the surface portions of the metal foil facing the depressions undergo a plastic deformation, thereby growing toward the spaces inside the depressions to become the protrusions 30. In this manner, the protrusions 30 having dimensions and shape corresponding to the spaces inside the depressions are formed at positions corresponding to the depressions. It should be noted that a negative electrode current collector with the protrusions 30 formed on both surfaces can be produced by pressing two forged steel rollers with a plurality of depressions formed in a surface against each other so that their axes are parallel to form a nip, and passing a metal foil through the nip.

The negative electrode active material layer 22 includes the granular particles 40 supported on the surfaces of the respective protrusions 30 of the central region 31 of the negative electrode current collector 21 and the thin films 41 supported on the surfaces of the respective protrusions 30 of the peripheral region 32. The surface of each protrusion of the peripheral region does not necessarily support the thin film including the alloyable active material.

In the central region 31, the granular particles 40 include the alloyable active material, and gaps 42 are formed between the adjacent granular particles 40. Therefore, even when the volume of the alloyable active material changes, it is possible to suppress fall-off of the granular particles 40 from the protrusions 30 or deformation of the negative electrode current collector 21 and the negative electrode 11.

The average height of the granular particles 40 is preferably 5 μm to 50 μm, and more preferably 5 μm to 30 μm. The average width of the granular particles 40 is preferably 5 μm to 30 μm. The height of each granular particle 40 is the length of the normal to the top face of the protrusion 30 from the highest point of the granular particle 40 in a section of the negative electrode 11. The width of each granular particle 40 is the greatest width of the granular particle 40 in a section parallel to the surface of the negative electrode current collector 21. The height and width of the granular particles 40 can be determined by observing a section of the negative electrode 11 with a scanning electron microscope, in the same manner as the height and width of the protrusions 30. Also, the granular particles 40 of this embodiment have columnar shapes like spindles, but the shape of the granular particles 40 is not particularly limited. For example, columnar shapes such as circular cylinders and prisms, spheres, substantial spheres, and ellipsoids may be used.

The alloyable active material included in the granular particles 40 is a substance which absorbs lithium to form an alloy with lithium and absorbs and releases lithium ions reversibly under the negative electrode potential. The alloyable active material is preferably amorphous or low-crystalline. While the alloyable active material can be any alloyable active material for lithium ion secondary batteries, preferable ones are silicon-based active materials and tin-based active materials. Such alloyable active materials can be used singly or in combination.

Examples of silicon-based active materials include silicon, silicon compounds, and partially substituted materials thereof.

Examples of silicon compounds include silicon oxides represented by the formula SiOₐ where 0.05<a<1.95, silicon carbides represented by the formula SiC_{b} where 0<b<1, silicon nitrides represented by the formula SiN_{c} where 0<c<4/3, and alloys of silicon and other element(s) M^{I}. Examples of other elements M^{I} include Fe, Co, Sb, Bi, Pb, Ni, Cu, Zn, Ge, In, Sn, and Ti. Also, partially substituted materials are compounds in which silicon atoms contained in silicon and the silicon compounds are partially replaced with other element(s) M^{II}. Examples of other elements M^{II} include B, Mg, Ni, Ti, Mo, Co, Ca, Cr, Cu, Fe, Mn, Nb, Ta, V, W, Zn, C, N, and Sn. Among silicon-based active materials, silicon and silicon oxides are preferable.

Examples of tin-based active materials include tin, tin compounds, and partially substituted materials thereof.

Examples of tin compounds include tin oxides represented by the formula SnO_{d} where 0<d≦2, composite oxides of tin and other metal(s) (e.g., SnSiO₃), tin nitrides, tin alloys such as Ni—Sn alloys, Mg—Sn alloys, Fe—Sn alloys, Cu—Sn alloys, and Ti—Sn alloys, and intermetallic compounds of tin and other metal(s) (e.g., Ni₂Sn₄ and Mg₂Sn). Among tin-based active materials, tin oxides, composite oxides, tin alloys, and intermetallic compounds are preferable.

In the peripheral region 32, the width W from the edge of the negative electrode current collector 21 to the edge 31a of the central region 31 is 20 μm to 500 μm, and preferably 20 μm to 200 μm. The width W is the length of the normal to the edge 31a of the central region 31 from a given point on the edge of the negative electrode current collector 21. If the width W is more than 500 μm, the side ends of the negative electrode 11 may bend, thereby damaging the separator 13. Also, if the width W is less than 20 μm, the granular particles 40 may be exposed at the side ends of the negative electrode 11 and the side end faces of the electrode assembly 10. In this case, during the production of the electrode assembly 10 or charging of the battery 1, the granular particles 40 may break at their basal portions, or the granular particles 40 may become chipped. The width of the peripheral region 32 does not need to be uniform over the whole peripheral region. When it is not uniform over the whole region, the smallest width needs to be within the above-mentioned range.

When the thin films 41 are formed on the protrusions on the surface of the negative electrode current collector 21 in the peripheral region 32, the alloyable active material forming the thin films 41 is the same as the alloyable active material forming the granular particles 40. The thickness of the thin films 41 is 5 μm or less, and preferably 0.5 μm to 5 μm. When the thickness of the thin films 41 is in this range, it is possible to more effectively suppress the thin films 41 from becoming chipped, and thus suppress chipped pieces from causing internal micro short circuits. Also, the thin films 41 are formed by destroying and removing the granular particles 40 upon cutting with a gable slitter 50, as will be described later. Thus, the surfaces of the thin films 41 may have minute irregularities or micro projections. The thickness of the thin films 41 can be determined in the same manner as the height of the granular particles 40.

Also, the ratio of the height of the granular particles 40 to the thickness of the thin films 41 (the height of the granular particles 40/the thickness of the thin films 41) is preferably in the range from 3 to 100, and more preferably in the range from 5 to 50. This ratio is determined by observing a section of the negative electrode 11 with a scanning electron microscope, measuring the heights of 100 granular particles 40 and the thicknesses of 100 thin films 41, and averaging the measured values. When this ratio is set in the above-mentioned range, the difference between the stress created by expansion of the granular particles 40 and the stress created by expansion of the thin films 41 is reduced at the border between the central region 31 and the peripheral region 32. Thus, at the border between the central region 31 and the peripheral region 32, fall-off of the granular particles 40 from the protrusions 30 or chipping of the granular particles 40 is more effectively suppressed, and the safety of the battery 1 is further improved.

The negative electrode 11 described above can be produced by a production method including the steps of: (1) producing a negative electrode sheet; and (2) cutting the negative electrode sheet produced in the previous step to predetermined dimensions with a gable slitter having an upper blade with a predetermined edge angle and a lower blade.

In the step (1), a negative electrode sheet in which the granular particle 40 is formed on the surface of each protrusion 30 of the negative electrode current collector 21 is produced. The granular particles 40 can be formed by vapor deposition. Examples of vapor deposition include vacuum deposition, sputtering, ion plating, laser ablation, chemical vapor deposition, plasma chemical vapor deposition, and thermal spraying. Among them, vacuum deposition is preferable.

According to vacuum deposition, the granular particles 40 can be produced, for example, as follows. A thin film Tₐ is formed by supplying vapor of an alloyable active material to each protrusion 30 at a predetermined incident angle Aᵢₐ and a thin film T_{b} is then formed at an incident angle A_{ib} which, together with the incident angle Aᵢₐ forms 180°. These steps of thin film formation are repeated to laminate the thin films Tₐ and the thin films T_{b} alternately, to form the granular particle 40. Based on the design dimensions and shape of the granular particles 40, the incident angles Aᵢₐ and A_{ib} the amount of vapor supplied, the time for forming the thin films Tₐ and T_{b}, the number of films laminated, etc. can be selected.

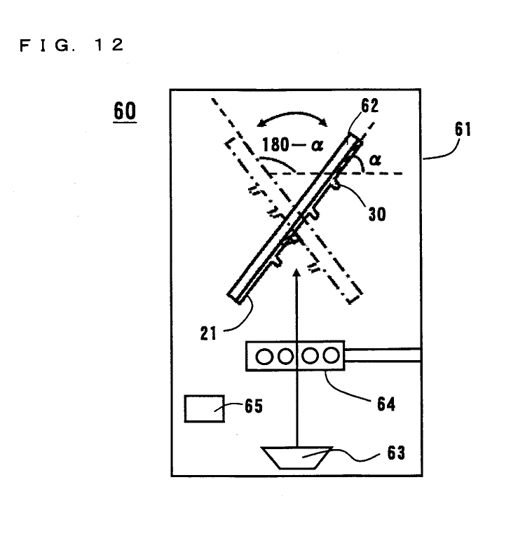

In the step (2), the negative electrode sheet produced by the step (1) is cut with the gable slitter, to obtain the negative electrode 11. The gable slitter used in the step (2) is described with reference to FIG. 10 and FIG. 11. FIG. 10 and FIG. 11 schematically illustrate the structure of the gable slitter 50. FIG. 10 is a side view of the gable slitter 50. FIG. 11 is a sectional view of the gable slitter 50. The gable slitter 50 has an upper blade 51 and a lower blade 52 which face each other, and is characterized in that the edge angle θ of the upper blade 51 is 40° to 65°. The upper blade 51 and the lower blade 52 are pressed against each other by disc springs (not shown). Thus, the shape of the upper blade is different from that of the lower blade. Further, the upper blade contacts with the lower blade.

By cutting a negative electrode sheet 53 to predetermined dimensions with the gable slitter 50, the negative electrode 11 including the negative electrode current collector 21 and the negative electrode active material layer 22 can be obtained. When the gable slitter 50 is used to cut the negative electrode sheet 53, the edge of the upper blade 51 is pressed against the negative electrode sheet 53. Thus, a suitable shearing force is applied to the negative electrode sheet 53, and the negative electrode sheet 53 can be cut while being bent. FIG. 11 shows that a shearing force is being applied to the negative electrode sheet 53 by the upper blade 51, with the negative electrode sheet 53 being bent toward the lower blade 52.

As such, in the cutting step, the granular particles 40 in the vicinity of the edge of the negative electrode current collector 21 are destroyed and removed substantially from their basal portions. Thus, only the portions of the granular particles 40 joined to the surfaces of the protrusions 30 remain and become the thin films 41, so that the peripheral region 32 is formed. The granular particles 40 on the region of the negative electrode current collector 21 excluding the peripheral region 32 remain undestroyed, so that the central region 31 is formed.

If the edge angle θ of the upper blade 51 is less than 40°, the shearing force applied to the negative electrode sheet 53 by the upper blade 51 decreases. Hence, the granular particles 40 may not be sufficiently destroyed and removed, and the granular particles 40 or the broken pieces thereof may be included in the electrode assembly 10. Further, the broken pieces of the granular particles may also occur from the basal portions remaining after the destruction and removal. On the other hand, if the edge angle θ of the upper blade 51 exceeds 65°, the shearing force applied to the negative electrode sheet 53 increases. Thus, the granular particles 40 in the region of the negative electrode current collector 21 excluding the peripheral region 32 may be destroyed and removed, thereby resulting in a decrease in the capacity of the negative electrode 11 and the battery 1.

While the material of the gable slitter 50 is not particularly limited, it is preferably high speed steel. When the gable slitter 50 made of high speed steel is used, the coefficient of friction of the gable slitter 50 against the negative electrode sheet 53 decreases. Thus, the granular particles can be efficiently destroyed and removed in the vicinity of the edge of the negative electrode current collector 21, in particular, in the region up to 500 μm from the edge. Also, abrasion of the gable slitter 50 itself can be suppressed, and inclusion of abrasion-induced metal powder into the electrode assembly 10 can be suppressed.

The cutting conditions using the gable slitter 50, such as the lap t of the upper blade 51 and the lower blade 52, the edge angle of the lower blade 52, the transport speed of the negative electrode sheet 53, and the contact pressure of the upper blade 51 with the negative electrode sheet 53, are not particularly limited. These conditions can be selected suitably according to the thickness of the negative electrode sheet 53, the dimensions of the granular particles 40, the pitch between the granular particles 40, the kind of the alloyable active material forming the granular particles 40, etc. Preferably, the lap t is 0.01 mm to 1 mm, the edge angle of the lower blade 52 is 2° to 20°, the transport speed of the negative electrode sheet 53 is 1 m/min to 50 m/min, and the contact pressure of the upper blade 51 with the negative electrode sheet 53 is 2 N to 10 N.

As described above, the negative electrode 11 can be obtained by cutting the negative electrode sheet 53 with the gable slitter 50. It should be noted that the width W of the peripheral region 32 can be adjusted by selecting the above-mentioned cutting conditions as well as the edge angle of the upper blade 51.

The negative electrode active material layer 22 of the negative electrode 11 may be supplemented with lithium corresponding to irreversible capacity before the battery 1 is assembled. Also, the negative electrode active material layer 22 may be supplemented with lithium corresponding to irreversible capacity by affixing a lithium foil to the surface of the negative electrode active material layer 22, assembling the battery 1, and applying an initial charge.

Next, the respective components of the battery 1 other than the negative electrode 11 are described one by one.

The positive electrode 12 includes a positive electrode current collector 12a and a positive electrode active material layer 12b supported on a surface of the positive electrode current collector 12a.

The positive electrode current collector 12a can be, for example, a metal foil made of a metal material such as aluminum, an aluminum alloy, stainless steel, or titanium. Among such metal materials, aluminum and aluminum alloys are preferable. While the thickness of the positive electrode current collector 12a is not particularly limited, it is preferably 10 μm to 30 μm.

The positive electrode active material layer 12b includes a positive electrode active material, a binder, and a conductive agent. The positive electrode active material layer 12b can be formed by, for example, applying a positive electrode mixture slurry to a surface of the positive electrode current collector 12a, drying the resulting coating film, and rolling it. The positive electrode mixture slurry can be prepared by, for example, mixing a positive electrode active material, a binder, a conductive agent, and a dispersion medium.

The positive electrode active material can be any positive electrode active material for lithium ion secondary batteries. Among them, lithium-containing composite oxides and olivine-type lithium salts are preferable.

Lithium-containing composite oxides are metal oxides including lithium and transition metal element(s), or metal oxides in which the transition metal element(s) contained in such metal oxides is/are partially replaced with other element(s). Examples of transition metal elements include Sc, Y, Mn, Fe, Co, Ni, Cu, and Cr. Among the transition metal elements, for example, Mn, Co, and Ni are preferable. Examples of other elements include Na, Mg, Zn, Al, Pb, Sb, and B. Among these other elements, for example, Mg and Al are preferable. Such transition metal elements and other elements can be used singly or in combination.

Examples of such lithium-containing composite oxides include Li_{q}CoO₂, Li_{q}NiO₂, Li_{q}MnO₂, Li_{q}COₘNi₁₋ₘO₂, Li_{q}COₘM₁₋ₘOₙ, Li_{q}Ni₁₋ₘMₘOₙ, Li_{q}Mn₂O₄, and Li_{q}Mn₂₋ₘMnO₄, where M is at least one element selected from the group consisting of Na, Mg, Sc, Y, Mn, Fe, Co, Ni, Cu, Zn, Al, Cr, Pb, Sb, and B, 0≦m≦0.9, and 2.0≦n≦2.3. Among them, Li_{q}COₘM₁₋ₘOₙ and Li_{q}Ni₁₋ₘMₘOₙ are preferable. In particular, lithium-containing composite oxides containing Mg or Al together with Ni and Co are preferable.

Examples of olivine-type lithium salts include LiXPO₄ and Li₂XPO₄F, where X is at least one element selected from the group consisting of Co, Ni, Mn, and Fe.

In the above formulas representing the lithium-containing composite oxides and olivine-type lithium salts, the molar ratios of lithium are the values immediately after the preparation thereof and decrease/increase due to charge/discharge. These positive electrode active materials can be used singly or in combination.

Examples of binders include resin materials such as polytetrafluoroethylene, polyvinylidene fluoride, and vinylidene fluoride-hexafluoropropylene copolymer, and rubber materials such as styrene butadiene rubber containing an acrylic acid monomer unit (trade name: BM-500B, available from Zeon Corporation) and styrene butadiene rubber (trade name: BM-400B, available from Zeon Corporation). These binders can be used singly or in combination.

Examples of conductive agents include carbon blacks such as acetylene black and ketjen black, and graphites such as natural graphites and artificial graphites. These conductive agents can be used singly or in combination.

Examples of the dispersion medium to be mixed with the positive electrode active material, binder and conductive agent include water and organic solvents such as N-methyl-2-pyrrolidone, tetrahydrofuran, and dimethylformamide.

The separator 13 to be disposed between the negative electrode 11 and the positive electrode 12 can be a porous polymer sheet, non-woven fabric made of resin fibers, or woven fabric made of resin fibers. Among them, a porous polymer sheet is preferable. The pore size of the porous polymer sheet is preferably about 0.05 μm to 0.15 μm. The thickness of the porous polymer sheet is preferably 5 μm to 30 μm. Examples of polymer or resin materials forming the porous polymer sheet and resin fibers include polyolefins such as polyethylene and polypropylene, polyamides, and polyamide-imides.

The non-aqueous electrolyte used to mainly impregnate the electrode assembly 10 includes a lithium salt and a non-aqueous solvent. Examples of lithium salts include LiPF₆, LiClO₄, LiBF₄, LiAlCl₄, LiSbF₆, LiSCN, LiAsF₆, LiB₁₀Cl₁₀, LiCl, LiBr, LiI, LiCO₂CF₃, LiSO₃CF₃, Li (SO₃CF₃)₂, LiN(SO₂CF₃)₂, and lithium imide salts. These lithium salts can be used singly or in combination. The concentration of the lithium salt in 1 L of the non-aqueous solvent is preferably 0.2 mol to 2 mol, and more preferably 0.5 mol to 1.5 mol.

Examples of non-aqueous solvents include cyclic carbonic acid esters such as ethylene carbonate, propylene carbonate, and butylene carbonate; chain carbonic acid esters such as dimethyl carbonate, ethyl methyl carbonate, and diethyl carbonate; chain ethers such as 1,2-dimethoxyethane and 1,2-diethoxyethane; cyclic carboxylic acid esters such as γ-butyrolactone and γ-valerolactone; and chain carboxylic acid esters such as methyl acetate. These non-aqueous solvents can be used singly or in combination.

The non-aqueous electrolyte can further contain additives. The functions of additives are not particularly limited, and various additives such as additives for increasing coulombic efficiency and additives for inactivating the battery can be used. Examples of additives include carbonate compounds with an unsaturated bond such as vinylene carbonate compounds and chain carbonate compounds with a vinyl group (e.g., vinyl ethylene carbonate and divinyl ethylene carbonate); and aromatic compounds such as cyclohexyl benzene, biphenyl, and diphenyl ether. Examples of vinylene carbonate compounds include vinylene carbonate, 4-methyl-vinylene carbonate, 4,5-dimethyl-vinylene carbonate, 4-ethyl-vinylene carbonate, and 4,5-diethyl-vinylene carbonate. These additives can be used singly or in combination.

The kind of the battery case 14 is not particularly limited, and any known battery case can be used. For example, it is possible to use a battery case that is produced by forming a laminated film comprising a resin material film and a metal material film into a predetermined shape. Also, the battery case 14 may be a battery case that is produced by forming an insulating material such as a resin material or a rubber material into a predetermined shape. The battery case 14 may be a battery case that is produced by forming a metal material into a predetermined shape.

The negative electrode lead 15 can be, for example, a nickel lead or a copper lead. The positive electrode lead 16 can be, for example, an aluminum lead.

The gasket 17 can be, for example, a gasket produced by forming an insulating material such as a resin material or a rubber material into a predetermined shape. In the case of using the battery case 14 made of a laminated film, the openings 14a and 14b can be directly welded for sealing without using the gaskets 17.

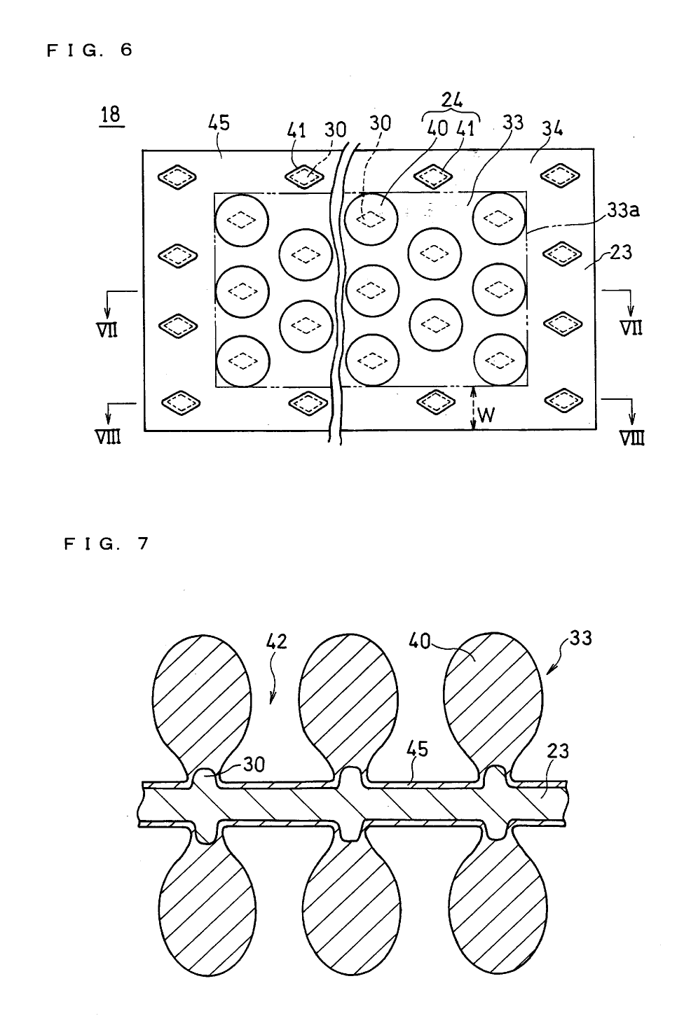

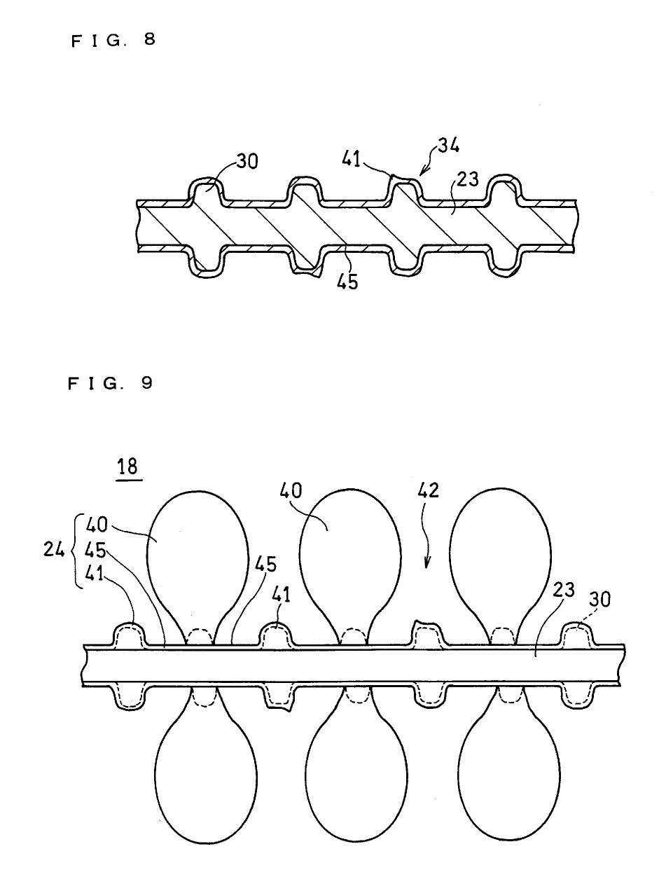

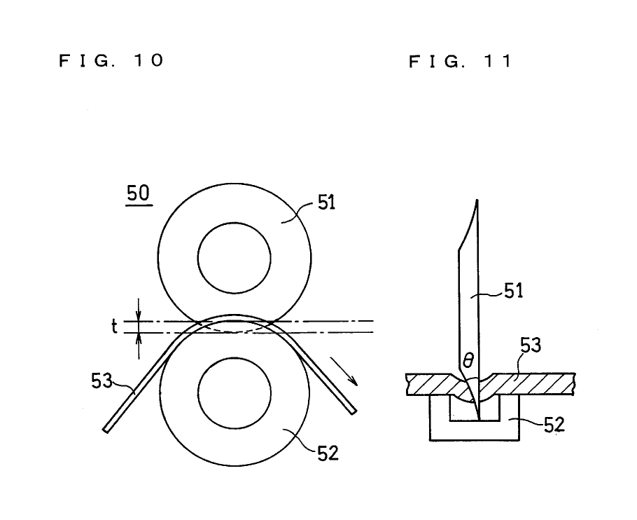

FIG. 6 is a schematic top view of the structure of a second embodiment of a negative electrode 18 for a lithium ion secondary battery according to the invention. FIG. 7 is a sectional view of the negative electrode 18 for a lithium ion secondary battery illustrated in FIG. 6 (hereinafter referred to as simply “negative electrode 18”) cut along the line VII-VII. FIG. 8 is a sectional view of the negative electrode 18 illustrated in FIG. 6 cut along the line VIII-VIII. FIG. 9 is a side view of the negative electrode 18.

The negative electrode 18 includes a strip-like negative electrode current collector 23 and negative electrode active material layers 24 supported on both surfaces of the negative electrode current collector 23.

The negative electrode current collector 23 has the same structure as the negative electrode current collector 21 of the negative electrode 11 illustrated in FIG. 2, except that it is shaped like a strip and has a plurality of protrusions 30 formed on both surfaces thereof.

As illustrated in FIG. 6 and FIG. 8, granular particles 40 are not supported on the protrusions 30 in a peripheral region 34 of the negative electrode current collector 23 with a specific width from the edge thereof. As illustrated in FIG. 6, FIG. 7, and FIG. 9, the granular particles 40 are supported on the protrusions 30 in a central region 33 surrounded by the peripheral region 34.

As illustrated in FIG. 7, FIG. 8, and FIG. 9, thin films 45 are supported on both surfaces of the negative electrode current collector 23 excluding the protrusions 30. That is, the thin film 45 is supported on each surface of the negative electrode current collector 23 irrespective of whether it is in the central region 33 or the peripheral region 34.

The central region 33 has an edge 33a shown by the dot-dot dashed line in FIG. 6 and comes into contact with the peripheral region 34 at the edge 33a, in the same manner as the central region 31. The central region 33 has the same structure as the central region 31 of the negative electrode 11 except that both surfaces thereof have the thin films 45 together with the granular particles 40.

The peripheral region 34 is the region from the edge of the negative electrode current collector 23 to the edge 33a of the central region 33, as illustrated in FIG. 6. In the peripheral region 34 on each surface of the negative electrode current collector 23, a plurality of thin films 41 are supported on the surfaces of the protrusions 30, and the thin film 45 is supported on the other region than the protrusions 30. The peripheral region 34 has the same structure as the peripheral region 32 of the negative electrode 11, except that the thin film 45 as well as the thin films 41 is supported on the peripheral region 34 on each surface of the negative electrode current collector 23.

The granular particles 40, the thin films 45, and the thin films 41 each include an alloyable active material. Thus, a negative electrode active material layer 24 includes the granular particles 40, the thin films 45, and the thin films 41. In this embodiment, as illustrated in FIG. 7 and FIG. 8, the granular particles 40 and the thin film 45 are connected at the basal portions of the granular particles 40, and the thin films 41 and the thin film 45 are connected to form a thin film. However, they do not have to be connected.

The negative electrode 18 is produced by, for example, as follows. First, on one surface of the negative electrode current collector 23, according to vacuum deposition, the granular particles 40 are formed on the surfaces of the respective protrusions 30 and the thin film 45 is formed on the part of the surface of the negative electrode current collector 23 having no protrusions 30. At this time, by selecting the incident angle of the vapor of the alloyable active material upon the negative electrode current collector 23 according to the height of the protrusions 30, the granular particles 40 and the thin film 45 can be formed simultaneously. Likewise, the granular particles 40 and the thin film 45 are formed on the other surface of the negative electrode current collector 23. In this manner, a negative electrode sheet having the granular particles 40 and the thin films 45 on both surfaces of the negative electrode current collector 23 is produced. The negative electrode sheet is cut with the gable slitter 50 illustrated in FIG. 10 and FIG. 11, to produce the negative electrode 18.

The negative electrode 18 is used to produce a wound electrode assembly. That is, a strip-like positive electrode, the negative electrode 18, and a strip-like separator interposed therebetween are wound to form a wound electrode assembly. The wound electrode assembly may be pressed to form the wound electrode assembly into a flat shape. When this wound electrode assembly is used to produce a lithium ion secondary battery, one end of a negative electrode lead and one end of a positive electrode lead are welded to a predetermined position of the negative electrode and a predetermined position of the positive electrode, respectively. The wound electrode assembly is then fitted with an upper insulator plate and a lower insulator plate. They are placed in a cylindrical battery case with a bottom, and a non-aqueous electrolyte is injected therein. Thereafter, the opening of the battery case is sequentially fitted with a gasket and a seal plate, and the open edge of the battery case is crimped onto the seal plate to seal the battery case. In this manner, the lithium ion secondary battery can be produced.

The battery case and the seal plate can be produced by, for example, forming a metal material such as iron or stainless steel into a predetermined shape. The upper insulator plate, lower insulator plate and gasket can be produced by, for example, forming an insulating material such as a resin material or a rubber material into a predetermined shape.

### EXAMPLE

The invention is hereinafter described specifically by way of Examples and Comparative Examples.

### Example 1

### (1) Preparation of Positive Electrode Plate

LiNi_{0.85}Co_{0.15}Al_{0.05}O₂, a lithium-containing nickel composite oxide containing cobalt and aluminum, was used as a positive electrode active material.

A positive electrode mixture slurry was prepared by mixing 85 parts by mass of the positive electrode active material, 10 parts by mass of a carbon powder, and an N-methyl-2-pyrrolidone solution containing 5 parts by mass of polyvinylidene fluoride. This positive electrode mixture slurry was applied onto one face of a 15-μm thick aluminum foil (positive electrode current collector), and the resulting coating film was dried and rolled to produce a 70-μm thick positive electrode. The positive electrode was cut to produce a positive electrode plate having a 20-mm square portion with the active material and a 5-mm square portion for attaching a lead.

### (2) Preparation of Negative Electrode Plate

### (2-1) Preparation of Negative Electrode Current Collector

A forged steel roller with a plurality of zigzag depressions in a surface was pressed against a stainless steel roller with a flat surface so that their axes were parallel, to form a nip. A 35-μm thick electrolytic copper foil (available from Furukawa Circuit Foil Co., Ltd.) was passed through the nip at a linear load of 1000 kg/cm, to produce a negative electrode current collector with a plurality of protrusions formed in a surface.

The protrusions had an average height of 8 μm and were arranged in a zigzag on the negative electrode current collector. Also, the top faces of the protrusions were flat planes substantially parallel to the surface of the negative electrode current collector. The shape of the protrusions was substantially rhombic in an orthographic projection from vertically above. Also, the axis-to-axis distance between the protrusions was 20 μm in the longitudinal direction of the negative electrode current collector and 15 μm in the width direction.

### (2-2) Formation of Negative Electrode Active Material Layer

FIG. 12 is a schematic view of the structure of an electron beam vacuum deposition device 60 (available from ULVAC, Inc.; hereinafter referred to as “deposition device 60”). In FIG. 12, the negative electrode current collector produced in (2-1) above is illustrated as a negative electrode current collector 21. The negative electrode current collector 21 has a plurality of protrusions 30 on a surface thereof.

The deposition device 60 has a chamber 61, which is a pressure-resistant container having therein a support table 62 for fixing the negative electrode current collector 21. Vertically below the support table 62 is a target 63 for housing a raw material of an alloyable active material. Between the support table 62 and the target 63 are a nozzle 64 for supplying a raw material gas such as oxygen or nitrogen and an electron beam generator 65 for irradiating the target 63 with an electron beam.

The support table 62 is rotatable between the position shown by the solid line in FIG. 12 (the position at which the support table 62 and a horizontal line cross each other at an angle α) and the position shown by the dot-dashed line (the position at which the support table 62 and a horizontal line cross each other at an angle 180−α). In this example, α=60°.

First, the support table 62 was set at the position shown by the solid line, and a thin film Tₐ was formed on the surface of each protrusion 30. Subsequently, the support table 62 was set at the position shown by the dot-dashed line, and a thin film T_{b} was laminated on the remaining part of the surface of each protrusion 30 and the surface of the thin film Tₐ in such a manner that the thin film T_{b} grew in a different direction from the growth direction of the thin film Tₐ. The support table 62 was alternately rotated 25 times between the position shown by the solid line and the position shown by the dot-dashed line, so that the thin films Tₐ and the thin films T_{b} were laminated alternately. In this manner, a granular particle 40 was formed on each protrusion 30 to produce a negative electrode sheet having a negative electrode active material layer including the granular particles 40.

Each of the granular particles 40, which had a substantially cylindrical shape, was grown from the top face of the protrusion 30 and the side face adjacent to the top face in such a manner that it extended outwardly from the surface of the negative electrode current collector 21. The heights of 100 granular particles 40 were measured, and the measured values were averaged. As a result, the average height was 20 μm. Also, the amount of oxygen contained in the granular particles 40 was determined by a combustion method. As a result, the composition of the granular particles 40 was SiO_{0.2}.

The deposition conditions were as follows.

Raw material for negative electrode active material (target 63): silicon, purity 99.9999%, available from Kojundo Chemical Lab. Co., Ltd.

Oxygen released from nozzle 64: purity 99.7%, available from Nippon Sanso Corporation

Flow rate of oxygen released from nozzle 64: 80 scan

Acceleration voltage of electron beam: −8 kV

Emission: 500 mA

Deposition time at the position shown by the solid line and the position shown by the dot-dashed line in FIG. 12: 3 minutes each

The negative electrode sheet prepared in the above manner was fixed to a predetermined position inside a resistance heating deposition device (available from ULVAC, Inc.), and lithium metal was mounted in a tantalum boat. The atmosphere inside the deposition device was replaced with an argon atmosphere, and a current of 50 A was passed through the tantalum boat to deposit lithium on the negative electrode sheet for 10 minutes. In this manner, the negative electrode sheet was supplemented with lithium corresponding to the irreversible capacity.

### (2-3) Cutting of Negative Electrode Sheet

The negative electrode sheet supplemented with lithium in (2-2) above was cut with a gable slitter (material: high speed steel SKH51, available from Toyo Knife Co., Ltd.). At this time, the edge angle of the upper blade was set to 45°, the edge angle of the lower blade was set to 5°, the lap t of the upper blade and the lower blade was set to 0.1 mm, the transport speed of the negative electrode sheet was set to 20 m/min, and the contact pressure of the upper blade with the negative electrode sheet was set to 3.5 N. In this manner, a negative electrode plate having a 21-mm square portion with the active material was produced. A surface of the negative electrode plate was provided with a 5-mm square portion for attaching a lead.

The negative electrode plate was observed with a scanning electron microscope. As a result, in a peripheral region 32 of the negative electrode current collector from the edge of the negative electrode plate up to 60 μm, the surface of each protrusion 30 was found to have a thin film 41 with a thickness of 0.5 μm to 4 μm. The composition of the thin films 41 was SiO_{0.2}, which is the same as that of the granular particles 40. The surfaces of the thin films 41 were found to have a large number of minute irregularities, which are the remains of the destroyed/removed granular particles 40. The thicknesses of 100 thin films 41 were measured, and the measured values were averaged. As a result, the average thickness was 2.5 μm. Thus, the height of the granular particles 40/the thickness of the thin films 41 was 8. The peripheral region 32 was present throughout the edge of the negative electrode plate. In a central region 31 surrounded by the peripheral region 32, the granular particles 40 remained on the surfaces of the protrusions 30. In this manner, the negative electrode plate with a negative electrode active material layer 22 having the granular particles 40 and the thin films 41 was produced.

### (3) Preparation of Non-Aqueous Electrolyte

LiPF₆ was dissolved in a solvent mixture of ethylene carbonate, ethyl methyl carbonate, and diethyl carbonate in a volume ratio of 2:3:5 at a concentration of 1.2 mol/L. This solution of 100 parts by mass was mixed with 5 parts by mass of vinylene carbonate to prepare a non-aqueous electrolyte.

### (4) Battery Assembly

A polyethylene porous film (thickness 20 μm, trade name: Hipore, available from Asahi Kasei Corporation) was interposed between the positive electrode plate and the negative electrode plate, and they were stacked to form a stacked electrode assembly. One end of an aluminum lead was welded to the positive electrode current collector, while one end of a nickel lead was welded to the negative electrode current collector. Subsequently, the stacked electrode assembly and the non-aqueous electrolyte were placed in a battery case made from an aluminum laminated film, and the other end of the aluminum lead and the other end of the nickel lead were drawn from the openings of the battery case. While the pressure inside the battery case was being reduced, the openings of the battery case were welded with polypropylene gaskets, to produce a lithium ion secondary battery (rated capacity 400 mAh) illustrated in FIG. 1.

### Example 2

A lithium ion secondary battery (rated capacity 400 mAh) was assembled in the same manner as in Example 1, except that in the production of a negative electrode plate, the edge angle of the upper blade of the gable slitter was changed to 60°.

The negative electrode plate after being cut with the gable slitter was observed with a scanning electron microscope. As a result, in a peripheral region 32 of the negative electrode current collector from the edge of the negative electrode plate up to 420 μm, the surface of each protrusion 30 was found to have a thin film 41 with a thickness of 0.5 μm to 5 μm. The composition of the thin films 41 was SiO_{0.2}, which is the same as that of the granular particles 40. The surfaces of the thin films 41 were found to have a large number of minute irregularities, which are the remains of the destroyed/removed granular particles 40. The thicknesses of 100 thin films 41 were measured, and the measured values were averaged. As a result, the average thickness was 4 μm. Thus, the height of the granular particles 40/the thickness of the thin films 41 was 5. The peripheral region 32 was present throughout the edge of the negative electrode plate. In a central region 31 surrounded by the peripheral region 32, the granular particles 40 remained on the surfaces of the protrusions 30. In this manner, the negative electrode plate with a negative electrode active material layer 22 having the granular particles 40 and the thin films 41 was produced.

### Example 3

A lithium ion secondary battery (rated capacity 400 mAh) was assembled in the same manner as in Example 1, except that in the production of a negative electrode plate, the edge angle of the upper blade of the gable slitter was changed to 50°.

The negative electrode plate after being cut with the gable slitter was observed with a scanning electron microscope. As a result, in a peripheral region 32 of the negative electrode current collector from the edge of the negative electrode plate up to 200 μm, the surface of each protrusion 30 was found to have a thin film 41 with a thickness of 0.5 μm to 4 μm. The composition of the thin films 41 was SiO_{0.2}, which is the same as that of the granular particles 40. The surfaces of the thin films 41 were found to have a large number of minute irregularities, which are the remains of the destroyed/removed granular particles 40. The thicknesses of 100 thin films 41 were measured, and the measured values were averaged. As a result, the average thickness was 3 μm. Thus, the height of the granular particles 40/the thickness of the thin films 41 was 6.7. The peripheral region 32 was present throughout the edge of the negative electrode plate. In a central region 31 surrounded by the peripheral region 32, the granular particles 40 remained on the surfaces of the protrusions 30. In this manner, the negative electrode plate with a negative electrode active material layer 22 having the granular particles 40 and the thin films 41 was produced.

### Comparative Example 1

A lithium ion secondary battery (rated capacity 400 mAh) was assembled in the same manner as in Example 1, except that in the production of a negative electrode plate, the edge angle of the upper blade of the gable slitter was changed to 35°. The negative electrode plate after being cut with the gable slitter was observed with a scanning electron microscope. As a result, it was found that the granular particles 40 remained on the peripheral region of the negative electrode plate.

### Comparative Example 2

A lithium ion secondary battery (rated capacity 400 mAh) was assembled in the same manner as in Example 1, except that in the production of a negative electrode plate, the edge angle of the upper blade of the gable slitter was changed to 70°. The negative electrode plate after being cut with the gable slitter was observed with a scanning electron microscope. As a result, it was found that no granular particles 40 remained on the peripheral region of the negative electrode plate. However, it was also found that some of the granular particles 40 did not remain in the region of the negative electrode plate excluding the peripheral region thereof.

### Comparative Example 3

A lithium ion secondary battery (rated capacity 400 mAh) was assembled in the same manner as in Example 1, except that in the production of a negative electrode plate, a gang slitter (material: simented carbide FW35 for both upper and lower blades, available from Kyocera Corporation) was used instead of the gable slitter. With respect to the cutting conditions with the gang slitter, the transport speed of the negative electrode sheet was set to 20 m/min and the pressure applied to the negative electrode sheet by the gang slitter was set to 2 N. The negative electrode plate after being cut with the gang slitter was observed with a scanning electron microscope. As a result, it was found that the granular particles 40 with a height of more than 5 μm remained on the peripheral region of the negative electrode plate.

The respective batteries produced in Examples 1 to 3 and Comparative Examples 1 to 3 were evaluated as follows. The results are shown in Table 1.

### [Cycle Characteristic]

The batteries of Examples 1 to 3 and Comparative Examples 1 to 3 were subjected to 200 charge/discharge cycles. In the charge/discharge at the 1^{st} cycle and the 200^{th} cycle, each battery was subjected to a constant-current charge (charge current 0.7 C, cut-off voltage 4.15 V) and a subsequent constant-voltage charge (charge voltage 4.15 V, cut-off current 0.05 C) in a 20° C. environment, and then subjected to a constant-current discharge (discharge current 0.2 C, cut-off voltage 2.0 V). The charge/discharge at the 2nd to 199^{th} cycles was performed under the same conditions as those at the 1^{st} cycle except that the current value for the constant current discharge was changed from 0.2 C to 1 C. The percentage of the discharge capacity at the 200^{th} cycle relative to the discharge cycle at the 1^{st} cycle was obtained as the capacity retention rate (%).

### [Presence or Absence of Internal Micro Short Circuits]

In the evaluation of the cycle characteristic, each battery subjected to the 200 charge/discharge cycles was disassembled, and the electrode assembly was taken out therefrom and observed with a scanning electron microscope to detect the presence or absence of internal micro short circuits. When the number of internal micro short circuits was less than 10, such a battery was evaluated as A. When the number of internal micro short circuits was from 10 to less than 20, such a battery was evaluated as B. When the number of internal micro short circuits was 20 or more, such a battery was evaluated as C.

TABLE 1

| | Capacity | Presence or absence |
|---|---|---|
| | retention | of internal micro |
| | rate (%) | short circuits |
| Example 1 | 83 | A |
| Example 2 | 83 | A |
| Example 3 | 84 | A |
| Comparative | 83 | C |
| Example 1 | | |
| Comparative | 72 | B |
| Example 2 | | |
| Comparative | 71 | B |
| Example 3 | | |

Table 1 clearly shows that the use of a negative electrode having a plurality of granular particles on the region of a negative electrode current collector excluding the peripheral region thereof increases the capacity retention rate of the battery and significantly reduces the occurrence of internal micro short circuits. Therefore, it is clear that the use of such a negative electrode improves the cycle characteristics and safety of alloy-type secondary batteries.

Further, it is clear that such a negative electrode can be produced by using a gable slitter with a predetermined edge angle to cut an alloy-type negative electrode sheet having a plurality of granular particles supported on a negative electrode current collector surface.

The lithium ion secondary battery of the invention can be used in the same applications as those of conventional lithium ion secondary batteries. In particular, it is useful as the main power source or auxiliary power source for electronic devices, electric devices, machine tools, transport devices, power storage devices, etc. Examples of electronic devices include personal computers, cellular phones, mobile devices, personal digital assistants, and portable game machines. Examples of electric devices include vacuum cleaners and video cameras. Examples of machine tools include power tools and robots. Examples of transport devices include electric vehicles, hybrid electric vehicles (HEVs), plug-in HEVs, and fuel cell cars. Examples of power storage devices include uninterruptible power supply systems.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A negative electrode for a lithium ion secondary battery, comprising a current collector and a negative electrode active material layer supported on a surface of the current collector, the negative electrode active material layer including a plurality of granular particles that comprise an alloyable active material, the granular particles being supported on a region of the current collector excluding a peripheral region that has a width of 20 μm to 500 μm from the edge thereof.

2. The negative electrode for a lithium ion secondary battery in accordance with claim 1, wherein the negative electrode active material layer further includes thin films comprising the alloyable active material, and the thin films are supported on the peripheral region.

3. The negative electrode for a lithium ion secondary battery in accordance with claim 2, wherein the surface of the current collector has a plurality of protrusions, and the granular particles and the thin films are supported on the protrusions.

4. The negative electrode for a lithium ion secondary battery in accordance with claim 2, wherein the ratio of the height of the granular particles to the thickness of the thin films is in the range from 3 to 100.

5. The negative electrode for a lithium ion secondary battery in accordance with claim 4, wherein the height of the granular particles is 5 μm to 50 μm, and the thickness of the thin films is 0.5 μm to 5 μm.

6. The negative electrode for a lithium ion secondary battery in accordance with claim 1, wherein the alloyable active material is at least one selected from the group consisting of silicon-based active materials and tin-based active materials.

7. A method for producing a negative electrode for a lithium ion secondary battery, comprising the steps of:
(1) forming a negative electrode active material layer including a plurality of granular particles that comprise an alloyable active material on a surface of a current collector to produce a negative electrode sheet; and
(2) cutting the negative electrode sheet to predetermined dimensions,
wherein the step (2) is performed with a gable slitter having an upper blade with an edge angle of 40° to 65° and a lower blade.

8. The method for producing a negative electrode for a lithium ion secondary battery in accordance with claim 7, wherein the gable slitter comprises high speed steel.

9. A lithium ion secondary battery comprising a positive electrode capable of absorbing and releasing lithium ions, a negative electrode capable of absorbing and releasing lithium ions, a separator interposed between the positive electrode and the negative electrode, and a lithium-ion conductive non-aqueous electrolyte,
wherein the negative electrode is the negative electrode of claim 1 for a lithium ion secondary battery.
